(19) United States
(12) Patent Application Publication
(10) Pub. No.: US 2016/0249255 A1
(43) Pub. Date: Aug. 25, 2016

(54) NETWORK SUPPORT FOR DIFFERENTIAL CHARGING FOR DATA USAGE IN LICENSED AND UNLICENSED FREQUENCY BANDS

(71) Applicant: Alcatel-Lucent USA Inc., Murray Hill, NJ (US)

(72) Inventors: Mohammad R. Khawer, Lake Hopatcong, NJ (US); Yigang Cai, Naperville, IL (US); Robert A. Soni, Randolph, NJ (US)

(21) Appl. No.: 14/631,310

(22) Filed: Feb. 25, 2015

(51) Int. Cl. H04W 36/00; H04M 15/00

(52) U.S. Cl. CPC H04W 36/0005; H04M 15/66; H04M 15/80

(57) ABSTRACT

Policy control and charging functionality in a network receives information indicating tariffs for a call session associated with a user equipment. The policy control and charging functionality defines, based on the information indicating the tariffs, a policy governing allocation of one or more licensed frequency bands and one or more unlicensed frequency bands to the call session. The policy and control charging functionality transmits the policy to a base station associated with the user equipment.

### CROSS REFERENCE TO RELATED APPLICATIONS

This application is related to U.S. patent application Ser. No. 14/607,803 (Attorney Docket No. 4100-817566-US), entitled “USER EQUIPMENT ASSISTED HANDOVER IN LICENSED AND UNLICENSED FREQUENCY BANDS” and filed on Jan. 28, 2015, the entirety of which is incorporated by reference herein, and U.S. patent application Ser. No. 14/607,790 (Attorney Docket No. 4100-817065-US), entitled “DIFFERENTIAL CHARGING FOR DATA USAGE IN LICENSED AND UNLICENSED FREQUENCY BANDS” and filed on Jan. 28, 2015, the entirety of which is incorporated by reference herein.

### BACKGROUND

1. Field of the Disclosure

The present disclosure relates generally to wireless communication systems and, more particularly, to licensed and unlicensed frequency bands in wireless communication systems.

2. Description of the Related Art

The demand for mobile wireless data has been growing at an exponential rate and is expected to continue to grow by many orders of magnitude in the coming years. Meeting the increasing demand will require a corresponding increase in the amount of spectrum available for wireless communication. The available spectrum can be increased by combining licensed frequency bands with unlicensed frequency bands. Unlicensed frequency bands are portions of the radiofrequency spectrum that do not require a license for use and may therefore be used by any device to transmit or receive radio frequency signals. For example, the Unlicensed National Information Infrastructure (UNII) is formed of portions of the radio spectrum that include frequency bands in the range of 5.15 GHz to 5.825 GHz such as the U-NII-1 band in the range 5.15-5.25 GHz, the U-NII 2a, b, c bands in the range 5.25-5.725 GHz, and the U-NII 3 band in the range 5.725-5.825 GHz. Unlicensed frequency bands can be contrasted to licensed frequency bands that are licensed to a particular service provider and may only be used for wireless communication that is authorized by the service provider. The cost of providing wireless data over licensed frequency bands differs from the cost of providing wireless data over unlicensed frequency bands. However, there is no mechanism in place for charging users for data transmitted over unlicensed frequency bands.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for network support of differential charging for data usage in licensed and unlicensed frequency bands. The method includes receiving information indicating tariffs for a call session associated with a user equipment. The method also includes defining, based on the information indicating the tariffs, a policy governing allocation of one or more licensed frequency bands and one or more unlicensed frequency bands to the call session. The method also includes transmitting the policy to a base station associated with the user equipment.

In some embodiments, a method is provided for storing policies for differential charging for data usage in licensed and unlicensed frequency bands. The method includes transmitting, from a base station, a request to establish a call session for a user equipment. The method also includes receiving, at the base station, a policy governing allocation of at least one licensed frequency band and at least one unlicensed frequency band to the call session. The policy is defined based on tariffs for the call session. The method further includes storing the policy at the base station.

In some embodiments, a non-transitory computer readable medium is provided that embodies a set of executable instructions to provide network support for differential charging for data usage in licensed and unlicensed frequency bands. The set of executable instructions manipulates a processor to receive information indicating tariffs for a call session associated with a user equipment. The set of executable instructions also manipulates the processor to define, based on the information indicating the tariffs, a policy governing allocation of one or more licensed frequency bands and one or more unlicensed frequency bands to the call session. The set of executable instructions also manipulates the processor to transmit the policy to a base station associated with the user equipment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a block diagram of a network charging system according to some embodiments.

FIG. 3 is a block diagram of a message that may be used to convey information associated with policies governing selective allocation of licensed and unlicensed frequency bands according to some embodiments.

FIG. 4 is a timing diagram of a method of defining policies and selectively allocating the licensed and unlicensed frequency bands based on the policies according to some embodiments.

FIG. 5 is a timing diagram of a method of defining policies and selectively allocating the licensed and unlicensed frequency bands based on policies that are modified in response to modification of the corresponding call session according to some embodiments.

FIG. 6 is a block diagram of a communication system according to some embodiments.

### DETAILED DESCRIPTION

Wireless communication systems can support differential charging for wireless data transmitted over licensed frequency bands and unlicensed frequency bands using a policy charging and rules function (PCRF) that establishes policies for allocating licensed frequency bands and unlicensed frequency bands to user equipment based on tariffs for the user equipment in the licensed and unlicensed frequency bands. In some embodiments, an online charging system (OCS) provides data usage tariffs to smart pricing functionality implemented in the PCRF, which generates the policies and transmits them to one or more base stations. The base stations may then use the policies to selectively allocate the licensed frequency bands and unlicensed frequency bands to the user equipment in response to the user equipment establishing a call session such as an Internet Protocol-Connectivity Access Network (IP-CAN) session with the PCRF.

Some embodiments of policies define one or more rules that indicate when the licensed or unlicensed frequency bands are to be allocated to the user equipment. For example, the policy may include a rule that indicates that the base station should hand over best effort data transmission for the session from a licensed frequency band to an unlicensed frequency if a data usage tariff for the unlicensed frequency band is less than a data usage tariff for the licensed frequency band. For another example, the policy may include a rule that indicates that the base station should hand over best effort data transmission for the session to the licensed or unlicensed frequency band that has the highest signal-to-noise ratio (SNR). Combinations of rules may also be used to selectively allocate the licensed and unlicensed frequency bands. The charging policies may include a time value that is used to indicate a valid duration of the charging policy. Some embodiments of the PCRF update the policies in response to expiration of the timer, in response to a request from the base station, in response to changing network conditions, or in response to other signaling.

Attribute-value pairs may be defined to convey information associated with the unlicensed frequency bands over interfaces between the PCRF and the OCS, interfaces between the PCRF and the gateway, or other interfaces. An attribute-value pair (which may also be referred to as a name-value pair, a key-value pair, or a field-value pair) is a data structure formed of a tuple that indicates the name of a particular attribute and a value of the attribute. For example, the tuple may have the form: <attribute name, value>. In some embodiments, the attribute-value pairs include information identifying an entity associated with the base station that supports communication in the unlicensed frequency bands, criteria for handing off between the licensed and unlicensed frequency bands, charging rules for the unlicensed frequency bands, activation or deactivation times for the rules, and the like.

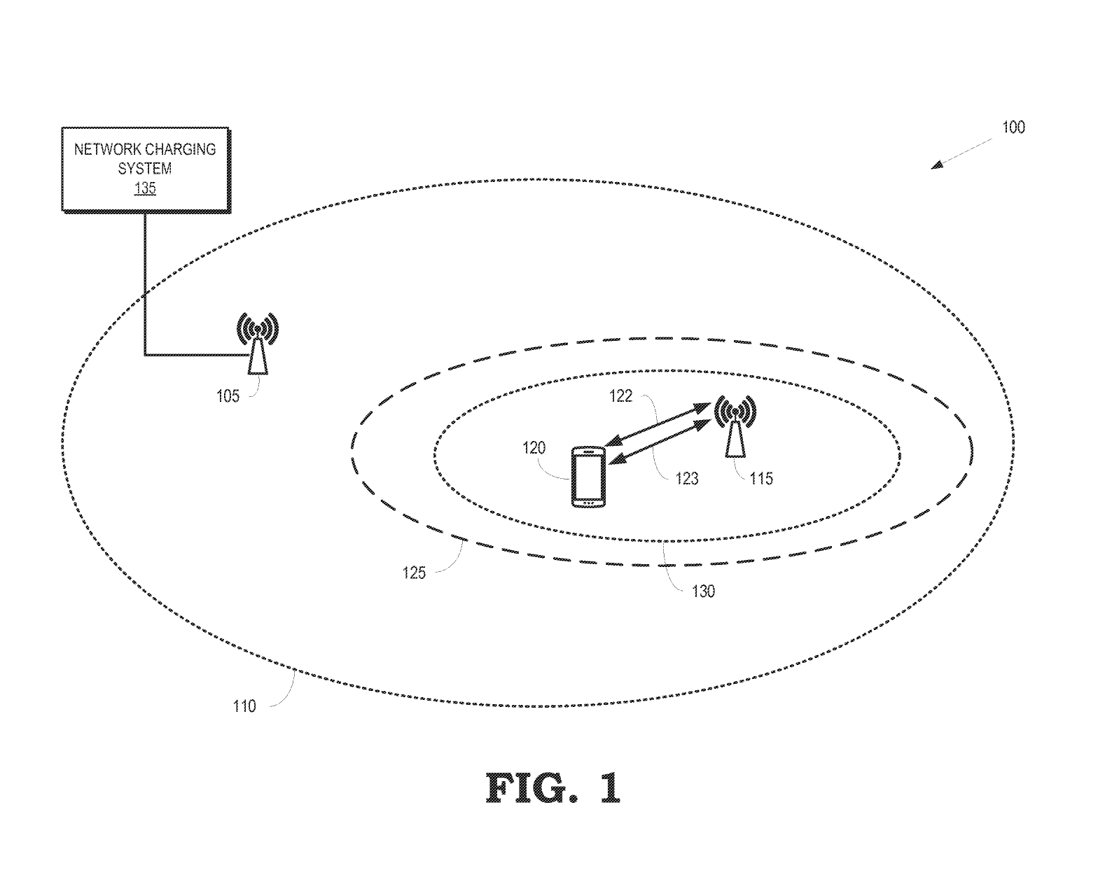

FIG. 1 is a diagram of a wireless communication system 100 according to some embodiments. The wireless communication system 100 includes one or more eNodeBs 105 that provide wireless connectivity according to a first radio access technology, e.g., according to the Long Term Evolution (LTE) standards defined by the Third Generation Partnership Project (3GPP). The eNodeB 105 provides wireless connectivity within a first geographical area or cell 110. The wireless communication system 100 also includes one or more small cells 115 that provide wireless connectivity according to the first radio access technology. As used herein, the term “base station” may be used to indicate eNodeBs that are part of a macrocellular network or small cells that overlay the macrocellular network. Small cells may also be referred to as home base station routers, metrocells, microcells, picocells, femtocells, and the like.

The small cell 115 may provide uplink or downlink communications to user equipment 120 over one or more carriers 122 in a licensed frequency band within the cell indicated by the dashed oval 125. The licensed carriers 122 may be referred to as LTE licensed (LTE-L) carriers. The small cell 115 may also support wireless connectivity over carriers 123 in one or more unlicensed frequency bands within a cell indicated by the dashed oval 130. The unlicensed carriers 123 may be referred to as LTE unlicensed (LTE-U) carriers. Some embodiments of the small cell 115 may also support wireless connectivity over other unlicensed carriers (not shown in FIG. 1) according to other radio access technologies such as Wi-Fi, as defined by the IEEE 802 standards. The unlicensed frequency bands may include the Unlicensed National Information Infrastructure (UNII), which is formed of portions of the radio spectrum that include frequency bands in the range of 5.15 GHz to 5.825 GHz such as the U-NII-1 band in the range 5.15-5.25 GHz, the U-NII 2a, b, c bands in the range 5.25-5.725 GHz, and the U-NII 3 band in the range 5.725-5.825 GHz. In some embodiments, the transmission power used by the small cell 115 to transmit signals in the licensed frequency band is larger than the transmission power used by the small cell 115 to transmit signals in the unlicensed frequency band. Consequently, the cell 125 is larger than the cell 130 in FIG. 1.

The small cell 115 may operate one or more of the unlicensed carriers 123 in different operating modes. For example, the small cell 115 may implement a supplemental downlink carrier in the unlicensed frequency band. The supplemental downlink carrier is used to carry best effort downlink data from the small cell 115 to the user equipment 120. A primary carrier is anchored in the licensed frequency band and is used to carry control data for the supplemental downlink carrier, as well as uplink data from the user equipment 120 to the small cell 115. For another example, the small cell 115 may implement a carrier aggregation mode in which a secondary carrier in the unlicensed frequency band carries both uplink and downlink best effort data. A primary carrier is anchored in the licensed frequency band and is used to carry control data for the secondary carrier.

As discussed herein, tariffs such as data usage tariffs may differ for data transmitted on the carrier 122 in the licensed frequency bands and data transmitted on the carrier 123 in the unlicensed frequency bands. The wireless communication system 100 can therefore be configured to support differential charging for wireless data transmitted over licensed frequency bands and unlicensed frequency bands. To support differential charging, a network charging system 135 generates policies that govern allocation of the licensed and unlicensed frequency bands on a per-user, per-call session basis. Some embodiments of the network charging system 135 include smart pricing functionality that generates policies for the user equipment 120 in response to the user equipment 120 requesting establishment of a call session with the small cell 115. The smart pricing functionality receives information indicating tariffs for the call session requested by the user equipment 120 and defines a policy governing allocation of the licensed or unlicensed frequency bands to the call session based on the received tariff information. The policies may then be transmitted to the small cell 115.

The small cell 115 can selectively allocate licensed frequency bands and unlicensed frequency bands to user equipment 120 based on the policy provided by the network charging system 135. Some embodiments of the small cell 115 implement a policy engine that determines whether to transmit data associated with a session over the carrier 122 in the licensed frequency band or the carrier 123 in the unlicensed frequency band based on a comparison of tariffs indicated in a charging policy. For example, the small cell 115 may hand over best effort data transmission for the session from the carrier 122 to the carrier 123 in response to the policy engine determining that a tariff for the unlicensed frequency band is less than a tariff for the licensed frequency band. The small cell 115 can collect and send charging parameters for the session (such as data usage, an indication of whether the data was transmitted in licensed or unlicensed frequency bands, a handover indicator, and the like) to the network charging system 135, which can determine the charges for the data usage and charge them to the correct user based on a session identifier, which identifies the session regardless of whether the data is transmitted in the licensed or unlicensed frequency band. Although the selective allocation is performed in the small cell 115 in the embodiment shown in FIG. 1, selective allocation as described herein may be performed by other types of base stations in some embodiments.

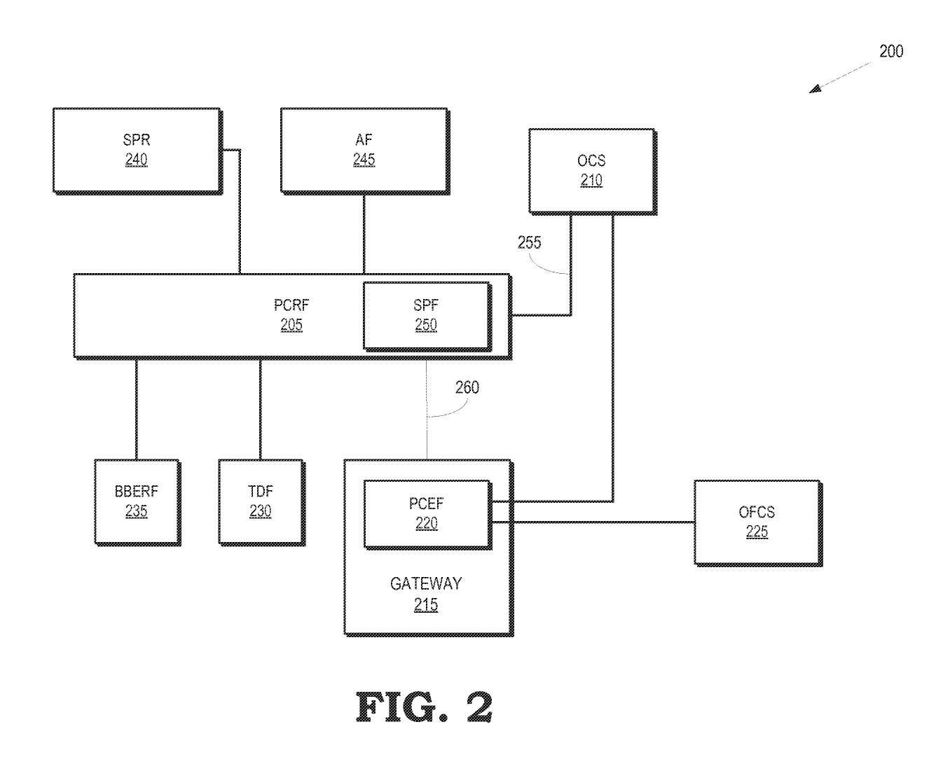

FIG. 2 is a block diagram of a network charging system 200 according to some embodiments. The network charging system 200 may be used to implement some embodiments of the network charging system 135 shown in FIG. 1. The network charging system 200 is used to determine a charge or an amount of money that is billed to an end-user. The architecture of the network charging system 200 may be defined according to the policy and charging control reference architecture defined by 3GPP TS 23.203, “Technical Specification Group Services and System Aspects, Policy and charging control architecture.” However, other embodiments of the network charging system 200 may be defined according to other reference architectures.

The network charging system 200 includes a policy control and charging rules function (PCRF) 205 that performs policy control decision-making and flow based charging control. An online charging system (OCS) 210 can provide data usage tariffs or policies to the PCRF 205 to indicate the data usage tariffs for licensed and unlicensed frequency bands such as LTE-L, LTE-U, and Wi-Fi. The OCS 210 may provide the information in either a push mode (e.g., without a specific request from the PCRF 205) or a pull mode (e.g., in response to a request from the PCRF 205). The charging policies may be determined based on a subscriber's charging account or an account associated with a group of subscribers. The data usage tariff for the unlicensed frequency band may be much lower than the data usage tariff for the licensed frequency band. However, some embodiments of the OCS 210 may determine the data usage tariffs based on other factors such as network traffic, location of the user equipment, quality of service, ownership of a base station, and the like. Thus, the data usage tariff for the unlicensed frequency band may in some cases be higher than the data usage tariff for the licensed frequency band.

The network charging system 200 also includes a gateway 215 such as a serving gateway (SGW) or a mobility management entity (MME) that is connected to the PCRF 205. The gateway 215 may be used to support communication between the network charging system 200 and base stations, eNodeBs, small cells, and the like. The gateway 215 includes a policy and charging enforcement function (PCEF) 220 that performs dataflow detection, policy enforcement, and flow-based charging. The OCS 210 may be connected to the PCEF 220 to provide policy information used by the PCEF 220. An off-line charging system (OFCS) 225 is also included in the network charging system 200 and is connected to the PCEF 220 to provide policies for off-line charging.

A traffic detection function (TDF) 230 performs application detection and reporting of detected applications. The TDF 230 also provides service data flow descriptors to the PCRF 205. A bearer binding and event reporting function (BBERF) 235 is used to perform bearer binding and binding verification, as well as providing event reporting to the PCRF 205. A subscription profile repository (SPR) 240 contains all subscriber/subscription related information needed for subscription-based policies. The SPR 240 also stores information indicating IP-CAN bearer level rules used by the PCRF 205. An application function (AF) 245 offers applications that may require dynamic policy or charging control. The AF 245 can communicate with the PCRF 205 to transfer dynamic session information to the PCRF 205.

Some embodiments of the PCRF 205 include a smart pricing function (SPF) 250 that is configured to generate charging policies and provide the charging policies to base stations such as the small cell 115 shown in FIG. 1. The PCRF 205 may generate the charging policies based on conditions in the base station such as conditions that may be detected by the TDF 230. The PCRF 205 may provide the charging policies to the base station in response to a request from a user equipment to establish a call session. For example, the gateway 215 may provide a request to the SPF 250 indicating that a user equipment has requested establishment of the call session. In response, the SPF requests data usage tariffs and other charging or policy information for the requested call session from the OCS 210, which provides the requested tariffs or charging/policy information over an interface 255 such as an Sy interface. The SPF 250 may then generate policies that govern the selective allocation of licensed and unlicensed frequency bands to the user equipment for the call session based on the information provided by the OCS 210, as well as other information that may be provided by other entities in the network charging system 200. Some embodiments of the PCRF 205 and the SPF 250 may proactively (e.g., without a specific request from the user equipment) request charging/policy information from the OCS 210 for user equipment and generate policies for the user equipment.

Some embodiments of the PCRF 205 may provide the charging policies to the gateway 215 over an interface 260 such as a Gx interface. The gateway 215 may then forward the charging policies to a base station (such as the eNodeB 105 shown in FIG. 1) for transmission to the base station. The gateway 215 may also provide the charging policies directly to the base station in some embodiments. The PCRF 205 may statically configure the base stations based on information provided by the service providers or the base stations may be dynamically configured, e.g. in response to changes in data service criteria as discussed below.

The information used to generate or define policies in the network charging system 200 may be transmitted over the interfaces 255, 260 in the form of attribute-value pairs included in messages transmitted over the interfaces 255, 260. In some embodiments, the attributes include identifiers of one or more unlicensed frequency bands such as unlicensed frequency bands used for LTE-U or Wi-Fi communication, handover criteria for the unlicensed frequency bands, charging rules for the unlicensed frequency bands, an activation time for the policy, and a deactivation time for the policy. Some embodiments of base stations include multiple functional units for supporting communication in multiple unlicensed frequency bands or according to different radio access technologies such as LTE and Wi-Fi. The identifiers may therefore include names/values that identify the different functional units within the base station. The handover criteria may be a group attribute-value pair that includes values indicating criteria rules, rule install, rule remove, rule definitions, rule names, and the like. The charging rule information may include charging rules, rule install, rule remove, rule definitions, rule names, and the like. The activation time and the deactivation time are timestamp attribute-value pairs indicating times for activating or deactivating the rules indicated in the policy provided to the base station. Values in the attribute-value pairs may be defined by the PCRF 205, the OCS 210, the gateway 215, the PCEF 220, the SPF 250, or other entities in the network charging system 200.

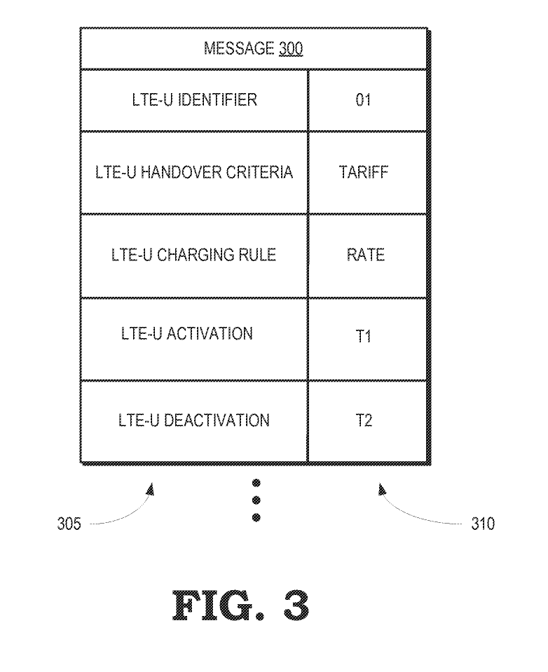

FIG. 3 is a block diagram of a message 300 that may be used to convey information associated with policies governing selective allocation of licensed and unlicensed frequency bands according to some embodiments. Some embodiments of the message 300 may be used to request tariff or policy information. For example, a PCRF such as the PCRF 205 shown in FIG. 2 may use embodiments of the messages 300 to request tariff or policy information from an OCS of the OCS 210 shown in FIG. 2. Some embodiments of the message 300 may be used to provide policies to base stations such as the small cell 115 shown in FIG. 1. For example, a PCRF may use embodiments of the message 300 to transmit policies to base stations via a gateway such as the gateway 215 shown in FIG. 2.

The message 300 includes one or more attribute-value pairs that are formed of attribute names 305 and corresponding values 310. One attribute-value pair in the message 300 is named “LTE-U IDENTIFIER” and the corresponding value “01” identifies a functional unit (such as a radio) within the corresponding small cell that supports LTE-U communication over an unlicensed frequency band. Another attribute-value pair in the message 300 is named “LTE-U HANDOVER CRITERIA” and has a value “TARIFF” that indicates a rule for handing off between a licensed frequency band and an unlicensed frequency band depending on which frequency band has a lower tariff. Another attribute-value pair in the message 300 is named “LTE-U CHARGING RULE” and has a value “RATE” that indicates a rate for billing data transmitted in the corresponding unlicensed frequency band. The message 300 also includes attribute-value pairs for “LTE-U ACTIVATION” that has a value “T1” to indicate when the policy is to be activated and “LTE-U DEACTIVATION” that has a value “T2” to indicate when the policy is to be deactivated.

The message 300 may also include other attribute-value pairs not shown in FIG. 1. For example, the message 300 may include attribute-value pairs for other radio access technologies such as Wi-Fi. For another example, the message 300 may include additional attribute-value pairs to define additional handover criteria such as threshold signal-to-noise ratios for handover between the licensed frequency bands in the unlicensed frequency bands. For yet another example, the message 300 may include additional attribute-value pairs to define additional charging rules such as rates for billing data transmitted on other licensed or unlicensed frequency bands. As discussed herein, the policies or rules indicated in some embodiments of the message 300 may be combined to determine rules for selectively allocating the licensed or unlicensed frequency bands. The policies or rules indicated in some embodiments of the message 300 may also be overridden so that the licensed or unlicensed frequency bands are selectively allocated based on other criteria evaluated at the base station.

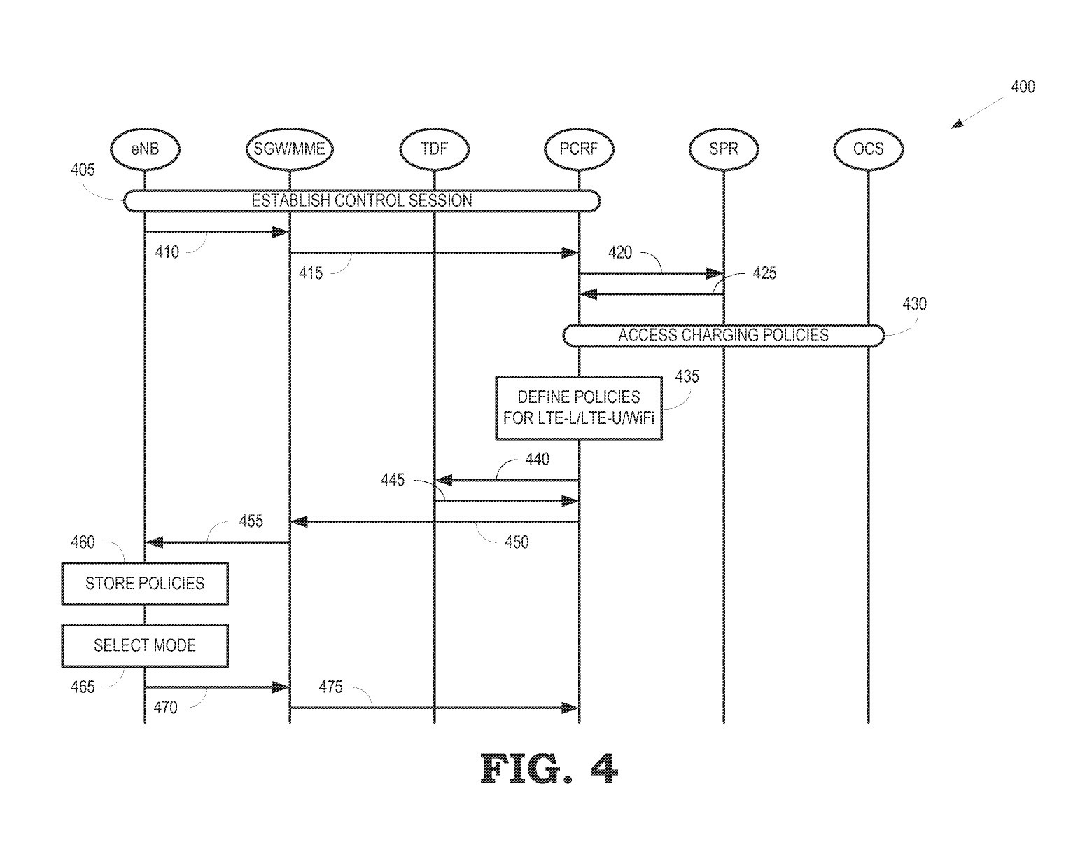

FIG. 4 is a timing diagram of a method 400 of defining policies and selectively allocating the licensed and unlicensed frequency bands based on the policies according to some embodiments. The method 400 may be implemented in some embodiments of the wireless communication system 100 shown in FIG. 1. At 405, a base station (eNB) establishes a control session with a PCRF in response to a request from the user equipment to establish a call session. The control session is established to provide control signaling over a licensed frequency band such as an LTE-L frequency band that is used to anchor the call session. The call session may also include a data session that is established over radio bearers (such as an IP-CAN bearer) in response to the request from the user equipment. The data session may be established using licensed frequency bands or unlicensed frequency bands that are selectively allocated by the base station based on policies generated by the PCRF. At 410, the base station provides a request to establish the radio bearers. For example, the base station may provide an IP-CAN bearer request to a gateway (SGW/MME), which forwards (at 415) the request to the PCRF over an interface such as a Gx interface. The request may include one or more attribute-value pairs, as discussed herein.

The PCRF requests (at 420) a profile for the user equipment from a subscription profile repository (SPR) such as the SPR 240 shown in FIG. 2. The SPR returns the requested profile at 425. In some embodiments, the profile includes information indicating a monthly allocation of bytes for data usage by the user equipment, a number or percentage of the monthly allocation that has already been used or is available for data usage, licensed (LTE-L) or unlicensed frequency bands (LTE-U, Wi-Fi) that are available to the subscriber, time of day constraints or discounts, and the like. At 430, the PCRF requests tariffs or other charging policy information from an online charging system (OCS) such as the OCS 210 shown in FIG. 2. The OCS may then provide this information to the PCRF. The tariffs may include information indicating tariffs for data transmitted over the licensed or unlicensed frequency bands that are available to the user equipment (as indicated in the profile information). The other charging policy information may include policies provided by service providers such as policies indicating that certain applications should preferentially use licensed or unlicensed frequency bands.

The PCRF defines (at 435) one or more policies based on the profile information, the tariffs, and (if available) other charging policy information. The policies include one or more rules for determining how licensed or unlicensed frequency bands are to be selectively allocated to the user equipment for the requested call session. For example, a rule may indicate that best effort traffic should be selectively allocated to the licensed or unlicensed frequency band that has the lowest tariff. In some embodiments, additional rules may be defined based on thresholds of measured parameters such as channel qualities, signal-to-noise ratios, received signal strengths, a speed or velocity of the user equipment, a location of the user equipment, ownership of a base station, and the like. Multiple sets of rules may be defined so that the base station can choose between the different sets of rules. In some embodiments, rules may be combined or overridden, as discussed herein. The PCRF then transmits (at 440) a request to establish a session with a traffic detection function (TDF) such as the TDF 230 shown in FIG. 2. The TDF responds (at 445) with a confirmation that the session has been established.

The PCRF transmits (at 450) a message to the gateway acknowledging the request to establish the call session. The message includes information defining policies for selective allocation of the licensed and unlicensed frequency bands. In some embodiments, the information defining the policies includes attribute-value pairs, as discussed herein. In response to receiving the acknowledgment, the gateway transmits (at 455) a response to the request from the base station to establish the IP-CAN bearer. The response includes information defining the policies for selective allocation of the licensed and unlicensed frequency bands. The base station stores (at 460) the information defining the policies so that this information can be subsequently used for selective allocation of the licensed or unlicensed frequency bands. For example, the information defining the policies may include an activation time or a deactivation time. The base station may selectively allocate the licensed or unlicensed frequency bands to the user equipment for the call session based on the policies without further consultation with the PCRF at times subsequent to the activation time and prior to the deactivation time. Some embodiments of the base station may request new policies in response to the current time being later than the deactivation time, in which case some or all of the steps 405, 410, 415, 420, 425, 430, 435, 440, 445, 450, 455, 460 may be repeated or iterated.

The base station selectively allocates (at 465) the licensed or unlicensed frequency bands based on the stored policies. Some embodiments of the base station may select an operational mode using rules indicated in the policies. For example, if a tariff for the unlicensed frequency band is less than a tariff for the licensed frequency band, the base station may select a supplemental downlink carrier mode so that best effort downlink data is conveyed to the user equipment in the unlicensed frequency band. For another example, if a tariff for the unlicensed frequency band is less than a tariff for the licensed frequency band, the base station may select a carrier aggregation mode so that both uplink and downlink best effort data are conveyed between the base station and the user equipment in the unlicensed frequency band. Some embodiments of the base station may override the stored policies in some circumstances. For example, the base station may override the stored policies if loading on the base station exceeds a threshold. The base station may then selectively allocate the licensed or unlicensed frequency bands to perform load balancing away from overloaded frequency bands and towards more lightly loaded frequency bands. For another example, the base station may override the stored policies based on channel conditions associated with the licensed frequency band or the unlicensed frequency band. The base station may then selectively allocate the licensed or unlicensed frequency bands to preferentially allocate the bands that have channel conditions above a threshold and avoid allocating the bands that have channel conditions below a threshold.

The base station transmits (at 470) a message to the gateway acknowledging establishment of the call session and the gateway forwards (at 475) the acknowledgment message to the PCRF. Some embodiments of the acknowledgment message may include information identifying the selected mode. The acknowledgment message may also include information indicating whether the operational mode was selected based on the provided policies or the policies were overridden.

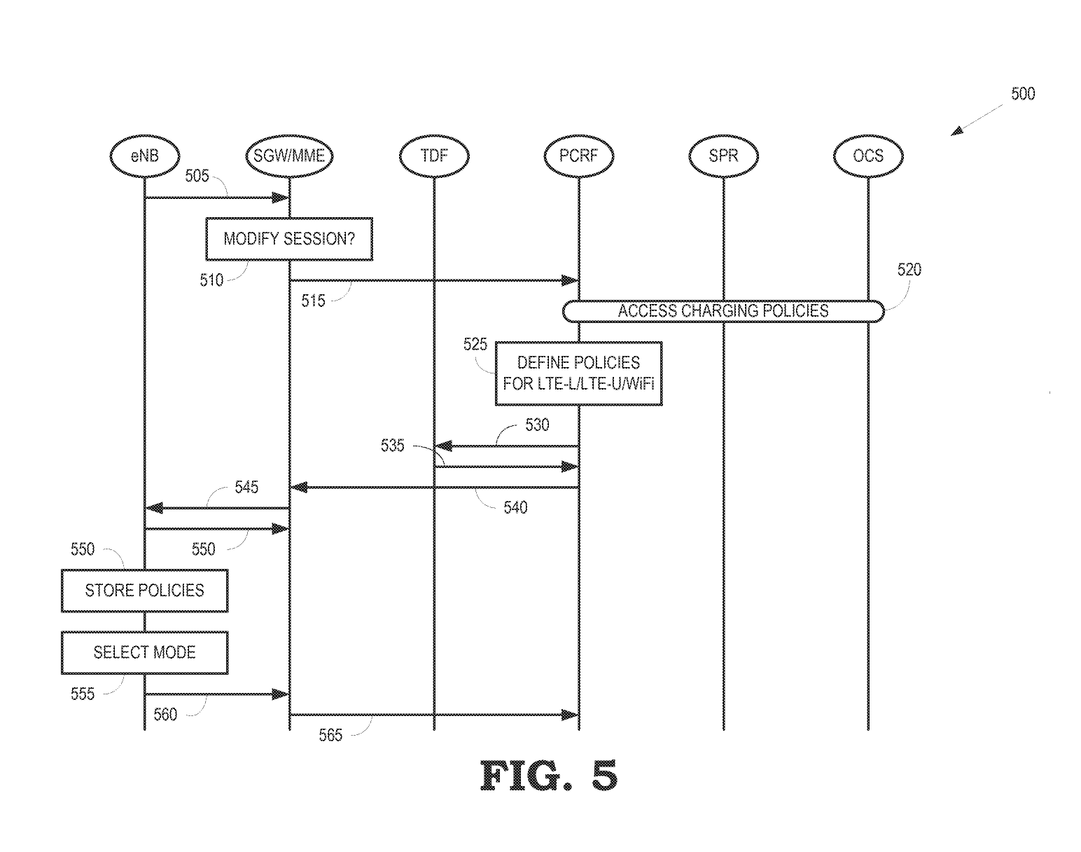

FIG. 5 is a timing diagram of a method 500 of defining policies and selectively allocating the licensed and unlicensed frequency bands based on policies that are modified in response to modification of the corresponding call session according to some embodiments. The method 500 may be implemented in some embodiments of the wireless communication system 100 shown in FIG. 1. Prior to step 505, a base station (eNB) has established a control session with a PCRF to support a call session for user equipment, e.g., according to embodiments of the method 400 shown in FIG. 4. For example, the call session may be used to transmit uplink or downlink data over radio bearers such as an IP-CAN bearer. The data session may be established using licensed frequency bands or unlicensed frequency bands that are selectively allocated by the base station based on policies generated by the PCRF.

At 505, the base station transmits a message to a gateway (SGW/MME) requesting a modification of the call session. Some embodiments of the base station may request modification of the call session in response to traffic changes, changes in loading of the base station, changes in channel conditions or signal strengths on the licensed or unlicensed frequency bands, user input to the user equipment indicating a requested modification, handover of one or more user equipment that are served by the base station, or other criteria. At 510, the gateway determines whether to modify the call session. If the gateway determines that the call session is to be modified in response to the request from the base station, the gateway transmits (at 515) a session modification request to the PCRF over an interface such as a Gx interface. The request may include one or more attribute-value pairs, as discussed herein. The values in the attribute-value pairs may differ from the values that were initially used to establish the call session to reflect the requested modification of the call session.

The PCRF requests (at 520) tariffs or other charging policy information for the modified call session from an OCS such as the OCS 210 shown in FIG. 2. The OCS may then provide this information to the PCRF. The tariffs may include information indicating tariffs for data transmitted over the licensed or unlicensed frequency bands that are available to the user equipment. The OCS 210 may use statically defined data usage tariffs or may dynamically determine the data usage tariffs based on factors such as network traffic, loading of the base station, location of the user equipment, quality of service, ownership of the base station, and the like. Thus, the data usage tariffs for the licensed or unlicensed frequency bands may change in response to the modifications in the call session. The other charging policy information may include policies provided by service providers such as policies indicating that certain applications should preferentially use licensed or unlicensed frequency bands.

The PCRF defines (at 525) one or more new policies for the user equipment based on previously accessed profile information, the new tariffs, and (if available) other charging policy information. The PCRF then transmits (at 530) a request to modify the existing session with a TDF such as the TDF 230 shown in FIG. 2. The TDF responds (at 535) with a confirmation that the session has been modified.

The PCRF transmits (at 540) a message to the gateway acknowledging the request to modify the call session. The message includes information defining the new policies for selective allocation of the licensed and unlicensed frequency bands. In some embodiments, the information defining the policies includes attribute-value pairs that include different values than were used to previously define the policies. In response to receiving the acknowledgment, the gateway transmits (at 545) a response to the request from the base station to establish the IP-CAN bearer. The response includes information defining the new policies for selective allocation of the licensed and unlicensed frequency bands. The base station stores (at 550) the information defining the new policies so that this information can be subsequently used for selective allocation of the licensed or unlicensed frequency bands. As discussed herein, the base station may request another new set of policies in response to the current time being later than a deactivation time indicated by the new policies.

The base station selectively allocates (at 555) the licensed or unlicensed frequency bands based on the stored new policies, as discussed herein. The base station then transmits (at 560) a message to the gateway acknowledging establishment of the call session and the gateway forwards (at 565) the acknowledgment message to the PCRF. Some embodiments of the acknowledgment message may include information identifying the selected mode for the modified call session. The acknowledgment message may also include information indicating whether the operational mode was selected based on the provided policies or the policies were overridden.

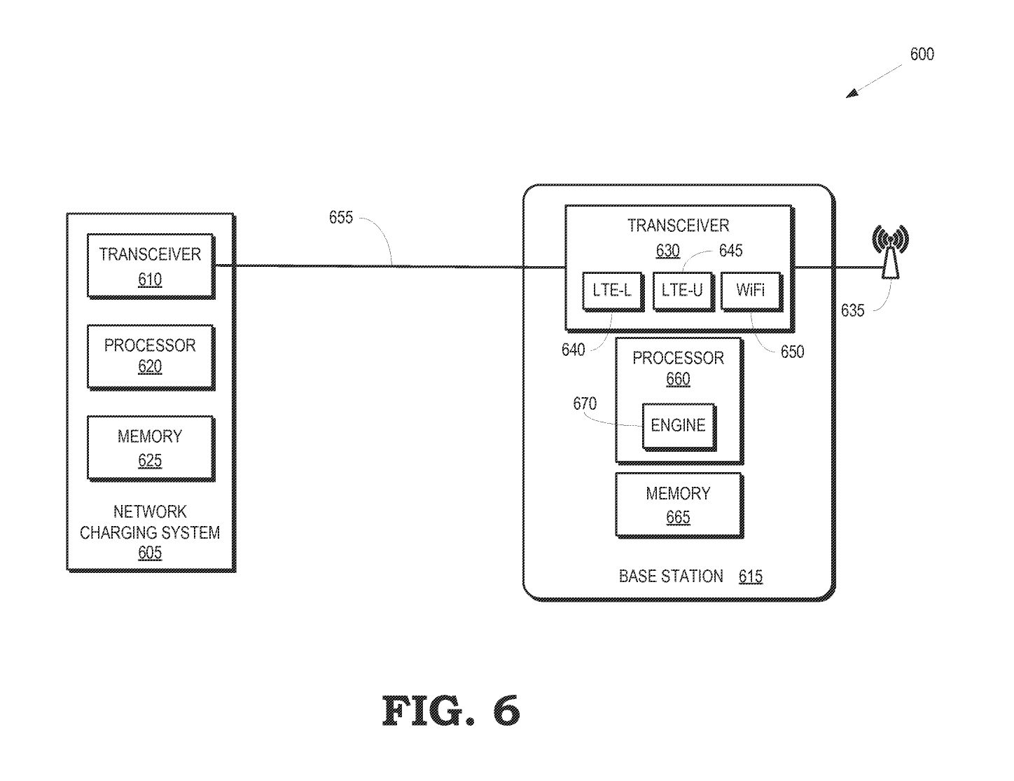

FIG. 6 is a block diagram of a communication system 600 according to some embodiments. The communication system 600 includes a network charging system 605 that generates and provides charging policies to entities in the communication system 600. Some embodiments of the network charging system 605 may be used to implement the network charging system 135 shown in FIG. 1 or the network charging system 200 shown in FIG. 2. The network charging system 605 includes a transceiver 610 for transmitting and receiving signals. For example, the network charging system 605 may generate charging policies and provide them to a base station 615, which may be used to implement embodiments of the small cell 115 shown in FIG. 1. The network charging system 605 also includes a processor 620 and a memory 625. The processor 620 may be used to execute instructions stored in the memory 625 and to store information in the memory 625 such as the results of the executed instructions. Some embodiments of the processor 620 and the memory 625 may be configured to perform portions of the method 400 shown in FIG. 4 or the method 500 shown in FIG. 5.

The base station 615 includes a transceiver 630 for transmitting and receiving signals via antenna 635. Some embodiments of the transceiver 630 include multiple radios for communicating according to different radio access technologies such as a radio 640 for communication in licensed LTE frequency bands (LTE-L), a radio 645 for communication in unlicensed LTE frequency bands (LTE-U), and a radio 650 for Wi-Fi communication in unlicensed frequency bands. For example, the LTE-L radio 640 may be used to communicate with user equipment in the licensed frequency band and the LTE-U radio 645 may be used to communicate with user equipment in the unlicensed frequency band. The base station 615 may receive charging policies generated by the network charging system 605 over the communication link 655.

The base station 615 also includes a processor 660 and a memory 665. The processor 660 may be used to execute instructions stored in the memory 665 and to store information in the memory 665 such as the results of the executed instructions. Some embodiments of the processor 660 and the memory 665 may be configured to perform portions of the method 400 shown in FIG. 4 or the method 500 shown in FIG. 5. For example, the processor 660 may implement a policy engine 670 that is used to selectively allocate licensed or unlicensed frequency bands (e.g., to selectively control operation of the radios 640, 645, 650) based on a charging policy provided by the network charging server 605 and stored in the memory 665.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving, at a policy charging and rules function (PCRF), information indicating tariffs for using at least one unlicensed frequency band and at least one licensed frequency band during a call session associated with a user equipment;
defining, at the PCRF based on the information indicating the tariffs, a policy governing allocation of the at least one licensed frequency band and the at least one unlicensed frequency band to the call session; and
transmitting the policy from the PCRF to a base station that supports wireless connectivity with the user equipment in the at least one unlicensed frequency band and the at least one licensed frequency band.

2. The method of claim 1, further comprising:
transmitting, from the PCRF, a request for the information indicating the tariffs in response to the PCRF receiving at least one of a request to establish the call session and a request to modify the call session, and wherein receiving the information indicating the tariffs comprises receiving the information indicating the tariffs in response to transmitting the request.

3. The method of claim 2, wherein transmitting the request for the information indicating the tariffs comprises transmitting a request including at least one first attribute-value pair associated with the at least one unlicensed frequency band.

4. The method of claim 3, wherein transmitting the policy to the base station comprises transmitting at least one second attribute-value pair associated with the at least one unlicensed frequency band.

5. The method of claim 4, wherein the at least one first attribute-value pair and the at least one second attribute-value pair are selected from a group comprising an identifier of the at least one unlicensed frequency band, handover criteria for the at least one unlicensed frequency band, a charging rule for the at least one unlicensed frequency band, an activation time for the policy, and a deactivation time for the policy.

6. The method of claim 5, further comprising:
receiving, at the PCRF, a request for a new policy from the base station subsequent to the deactivation time;
defining, at the PCRF, the new policy based on information indicating new data usage tariffs for the at least one unlicensed frequency band and the at least one licensed frequency band, the new data usage tariffs being received in response to the request for the new policy; and
transmitting the new policy from the PCRF to the base station with a new de-activation time.

7. The method of claim 1, wherein defining the policy comprises defining a policy indicating that a best effort data transmission is to be handed over from a licensed frequency band to an unlicensed frequency band in response to a data usage tariff for the unlicensed frequency band being less than a data usage tariff for the licensed frequency band, wherein control data for the best effort data transmission is conveyed in the licensed frequency band.

8. The method of claim 1, wherein defining the policy comprises defining the policy based on at least one of a signal-to-noise ratio, a received signal strength, a speed or velocity of a user equipment, a location of the user equipment, the tariffs, and ownership of the base station.

9. A method comprising:
transmitting, from a base station that supports wireless connectivity in at least one licensed frequency band and at least one unlicensed frequency band, a request to establish a call session for a user equipment;
receiving, at the base station from a policy charging and rules function (PCRF), a policy governing allocation of the at least one licensed frequency band and the at least one unlicensed frequency band to the call session, wherein the policy is defined by the PCRF based on data usage tariffs for the at least one licensed frequency band and the at least one unlicensed frequency bands during the call session; and
storing the policy at the base station.

10. The method of claim 9, further comprising:
at the base station, selectively allocating the at least one licensed frequency band and the at least one unlicensed frequency band to the call session based on the policy.

11. The method of claim 10, wherein selectively allocating the at least one licensed frequency band and the at least one unlicensed frequency band comprises handing over best effort data transmission from a licensed frequency band to an unlicensed frequency band in response to a data usage tariff for the unlicensed frequency band being less than a data usage tariff for the licensed frequency band, wherein control data for the best effort data transmission is conveyed in the licensed frequency band.

12. The method of claim 9, further comprising:
at the base station, overriding the policy to selectively allocate the at least one licensed frequency band and the at least one unlicensed frequency band to the call session; and
at the base station, selectively allocating the at least one licensed frequency band and the at least one unlicensed frequency band to the call session based on at least one of a channel condition of the at least one licensed frequency band, a channel condition of the at least one unlicensed frequency band, and a load on the base station.

13. The method of claim 9, wherein receiving the policy comprises receiving at least one attribute-value pair associated with the at least one unlicensed frequency band.

14. The method of claim 13, wherein the at least one attribute-value pair is selected from a group comprising an identifier of the at least one unlicensed frequency band, handover criteria for the at least one unlicensed frequency band, a charging rule for the at least one unlicensed frequency band, an activation time for the policy, and a deactivation time for the policy.

15. The method of claim 14, further comprising:
providing a request to modify the call session subsequent to establishing the call session.

16. The method of claim 15, wherein providing the request to modify the call session comprises providing the request to modify the call session in response to at least one of a change in a load on the base station, a change in a channel condition of the at least one licensed frequency band, a change in a channel condition of the at least one unlicensed frequency band, handover of one or more other user equipment, and user input to the user equipment.

17. The method of claim 14, further comprising:
providing a request for a new policy subsequent to the deactivation time; and
receiving, in response to the request for the new policy, the new policy with a new de-activation time.

18. A non-transitory computer readable medium embodying a set of executable instructions, the set of executable instructions to manipulate a processor that is implemented in a policy charging and rules function (PCRF) to:
receive information indicating data usage tariffs for at least one licensed frequency band and at least one unlicensed frequency band during a call session associated with a user equipment;
define, based on the information indicating the data usage tariffs, a policy governing allocation of the at least one licensed frequency band and the at least one unlicensed frequency band to the call session; and
transmit the policy to a base station that supports wireless connectivity with the user equipment in the at least one licensed frequency band and the at least one unlicensed frequency band.

19. The non-transitory computer readable medium of claim 18, wherein the set of executable instructions is to manipulate the processor to transmit a request for the information indicating the data usage tariffs in response to receiving a request to establish or modify the call session, and wherein receiving the information indicating the data usage tariffs comprises receiving the information indicating the data usage tariffs in response to transmitting the request.

20. The non-transitory computer readable medium of claim 18, wherein the set of executable instructions is to manipulate the processor to define a policy indicating that best effort data transmission is to be handed over from a licensed frequency band to an unlicensed frequency band in response to a data usage tariff for the unlicensed frequency band being less than a data usage tariff for the licensed frequency band.
